(19) United States
(12) Patent Application Publication
(10) Pub. No.: US 2019/0160553 A1
(43) Pub. Date: May 30, 2019

(54) ALIGNMENT DEVICE AND METHODS OF MAKING AND USING THE SAME

(71) Applicant: John Pertschi, Mebane, NC (US)

(72) Inventor: John Pertschi, Mebane, NC (US)

(21) Appl. No.: 15/826,790

(22) Filed: Nov. 30, 2017

(51) Int. Cl. B23B 49/00; G01C 9/32; G01B 11/27; B23B 35/00; E04G 21/16

(52) U.S. Cl. CPC B23B 49/00; G01C 9/32; B23B 2270/34; B23B 35/00; E04G 21/16; G01B 11/27

(57) ABSTRACT

The presently disclosed subject matter is directed to a pipe fitting alignment device. Particularly, the disclosed device comprises a cup configured to fit over one end of a pipe, a slope level, and a laser unit. The device provides a quick and accurate way to locate marks for drilling multiple holes that slope at a desired angle. As a result, the need to measure, level, and mark individual joists is eliminated. Accordingly, the device reduces the need for line levels, traditional torpedo levels, plumb lines, caulk lines, sight wires, level sticks, etc. and allows one person to pinpoint drilling locations and accurately align components and structures to desired slopes.

### TECHNICAL FIELD

The presently disclosed subject matter relates to the field of alignment and sighting. Particularly, the presently disclosed subject matter is directed to a device and method for accurately projecting a path for the drilling of multiple in-line sloped holes.

### BACKGROUND

Drain pipes form an important part of any plumbing installation. Local ordinances and building codes generally require that drain pipes be installed with a slight pitch or downward slope leading away from the plumbing installation to help prevent waste and drain water from backing up into the house or building plumbing system. The angle of downward slope can vary according to the diameter of the drain pipe, use of the pipe, and so forth. A common requirement is that a drain or sewer line three inches or less in diameter must slope vertically downward one-quarter inch per foot of travel, while drain pipes greater than three inches in diameter must slope vertically downward one-eighth of an inch downward for each foot of travel. Traditionally, the slope between adjacent joists have been individually measured and drilled, requiring significant time and attention to detail. Commonly, measurements are miscalculated, leading to considerable construction defects that can be costly to repair. It would therefore be beneficial to provide a device that produces the accurate projection of a path for the drilling of multiple aligned holes for a succession of construction joists.

### SUMMARY

In some embodiments, the presently disclosed subject matter is directed to a device for sloped laser sighting. The device comprises a cup comprising an interior, an open first end, a closed second end, and a sidewall that connects the open first end and the closed second end. The closed second end comprises a face with an aperture configured therein, and the interior comprises a housing positioned adjacent to the closed second end, sized and shaped to contain a laser unit. The device further comprises a slope level comprising an interior that houses a liquid and a bubble of gaseous fluid disposed at a location within the liquid, wherein the location is an indicator of slope of the device. The device also includes a laser unit disposed within the cup housing, wherein one end of the laser unit extends through the aperture, and wherein the extended end is configured to emit a light therefrom. In some embodiments, the sidewall tapers inward from the first open end of the cup to the second closed end.

In some embodiments, the device sidewall has an exterior that comprises a brace sized and shaped to house the slope level.

In some embodiments, the cup is constructed from plastic, metal, wood, cardboard, chipboard, stiff paper, foamed plastics, recycled materials, compostable materials, heavy foil, or combinations thereof.

In some embodiments, the slope level comprises markings that indicate a downward slope of ⅛ inch, ¼ inch, or ½ inch per foot.

In some embodiments, the liquid of the slope level is colored to increase visibility.

In some embodiments, the laser unit is releasably disposed within the housing.

In some embodiments, the sidewall has an outer surface that comprises a brace that releasably houses the slope level.

In some embodiments, the open first end of the cup is configured to fit over one end of a pipe.

In some embodiments, the laser unit comprises an internal battery source for energizing a beam circuitry.

In some embodiments, the presently disclosed subject matter is directed to a method of marking a hole location at a desired slope in a structure. The method comprises positioning the disclosed device for sloped laser sighting on one end a pipe, tilting the device to a desired slope as indicated by the bubble location in the slope level, and initiating the laser unit to emit light to mark a location for a first hole in a first structure where indicated by the laser. In some embodiments, the method further comprises drilling a hole in the first structure at the location marked, and marking a location for a second hole in a second structure where indicated by the emitted light passing through the first hole to align the first hole in the first structure with the marked location on the second structure at a desired slope.

In some embodiments, the structure is a joist.

In some embodiments, the desired slope is a downward slope of ⅛ inch, ¼ inch, or ½ inch per foot.

In some embodiments, the laser unit is releasably disposed within the housing.

In some embodiments, the sidewall has an outer surface that comprises a brace that releasably houses the slope level.

In some embodiments, the presently disclosed subject matter is directed to a method of forming a plurality of aligned holes. The method comprises positioning the disclosed device for sloped laser sighting on one end a pipe, tilting the device to a desired slope as indicated by the bubble location in the slope level, and initiating the laser unit to emit light to mark a location for a first hole in a first structure where indicated by the laser. The method further comprises drilling a hole at the marked location in the first structure, marking a location for a second hole in a second structure where indicated by the emitted light passing through the first hole, and drilling a second hole in the location marked on the second structure, wherein the first hole and the second hole are aligned at a desired slope.

In some embodiments, the first and second structures are joists.

In some embodiments, the method further comprises drilling one or more successive holes marked on successive structures, wherein the successive holes are aligned with the first and second holes at a desired slope.

### BRIEF DESCRIPTION OF THE DRAWINGS

The previous summary and the following detailed descriptions are to be read in view of the drawings, which illustrate some (but not all) embodiments of the presently disclosed subject matter.

FIGS. 1a and 1b are perspective views of an alignment device in accordance with some embodiments of the presently disclosed subject matter.

FIG. 2a is a front perspective view of an alignment device cup in accordance with some embodiments of the presently disclosed subject matter.

FIG. 2b is a rear perspective view of an alignment device cup in accordance with some embodiments of the presently disclosed subject matter.

FIG. 2c is a cutaway view of the cup of FIGS. 2a and 2b.

FIGS. 2d and 2e are cutaway views of alternate embodiments of a device cup.

FIG. 3a is a perspective view of a slope level in accordance with some embodiments of the presently disclosed subject matter.

FIG. 3b is a front plan view of the slope level of FIG. 3a.

FIG. 3c is a front plan view of a slope level and corresponding housing in accordance with some embodiments of the presently disclosed subject matter.

FIG. 4 is a perspective view of a laser unit in accordance with some embodiments of the presently disclosed subject matter.

FIGS. 5a-5e illustrate one embodiment of the disclosed alignment device in use.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

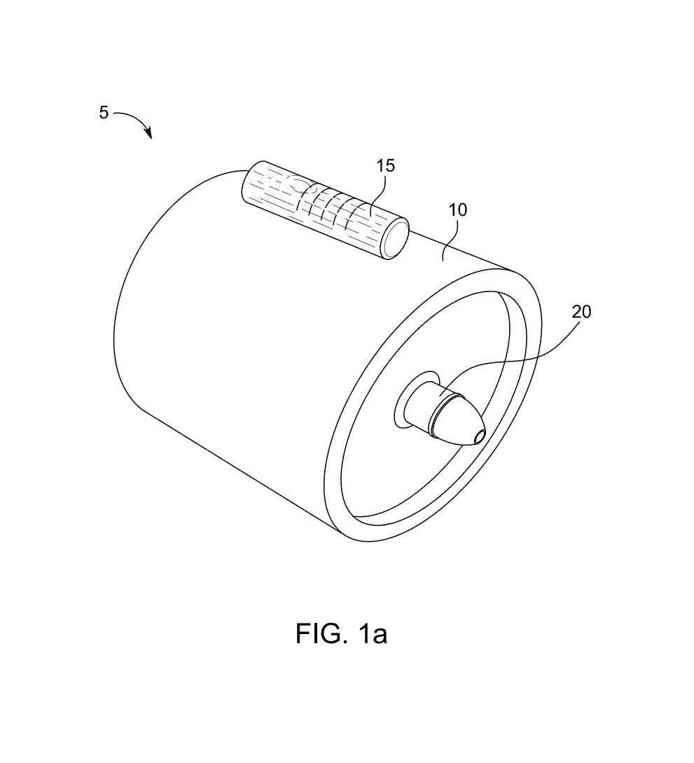

The presently disclosed subject matter relates generally to a pipe fitting alignment device. Particularly, as shown in FIGS. 1a and 1b, device 5 comprises cup 10, slope level 15, and laser unit 20. Device 5 provides a quick and accurate way to locate marks for drilling multiple holes that slope at a desired angle. As a result, the need to measure, level, and mark individual joists is eliminated. Accordingly, device 5 is a labor saving tool that reduces the need for line levels, traditional torpedo levels, plumb lines, caulk lines, sight wires, level sticks, etc. and allows one person (instead of multiple workers) to pinpoint drilling locations and accurately align components and structures to exacting tolerances.

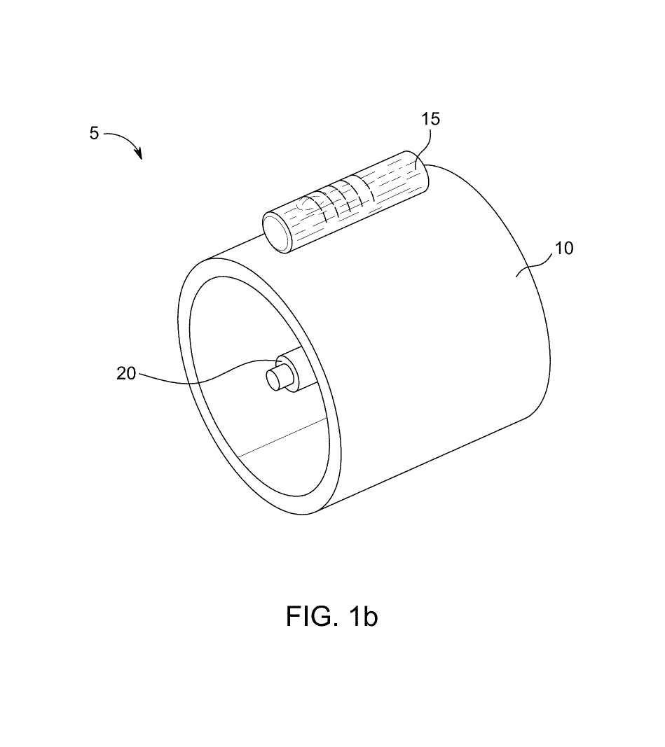

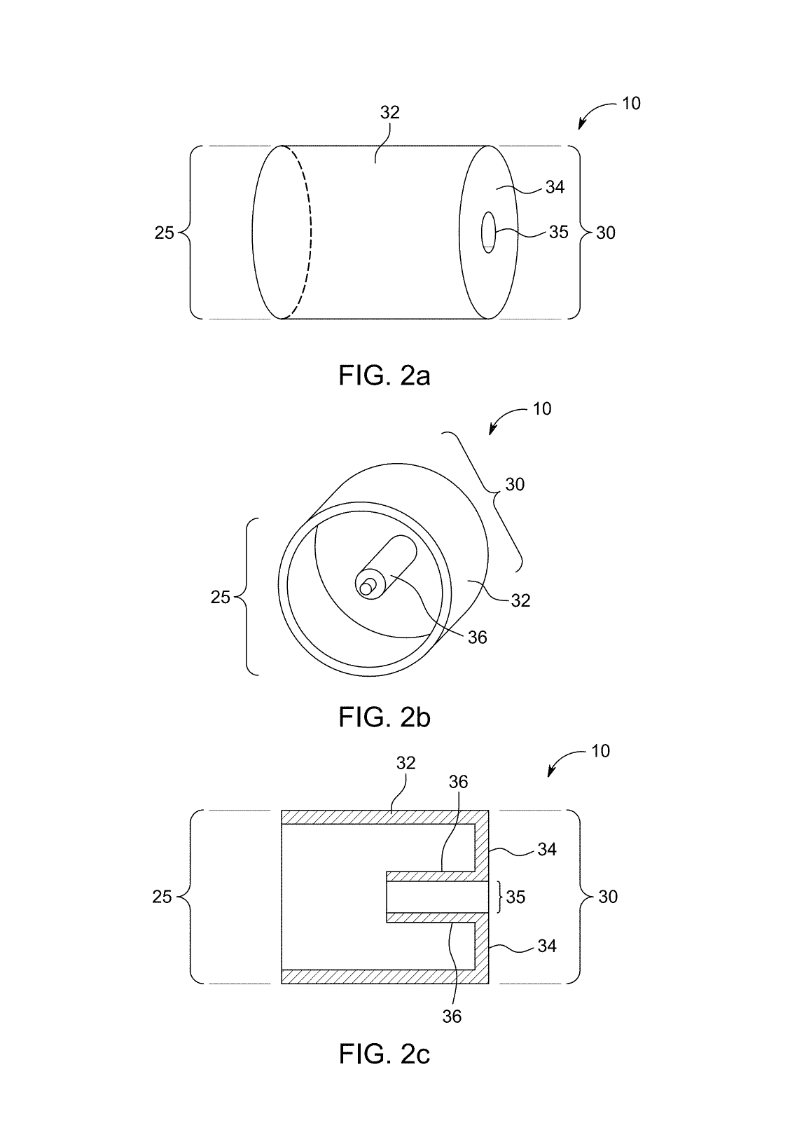

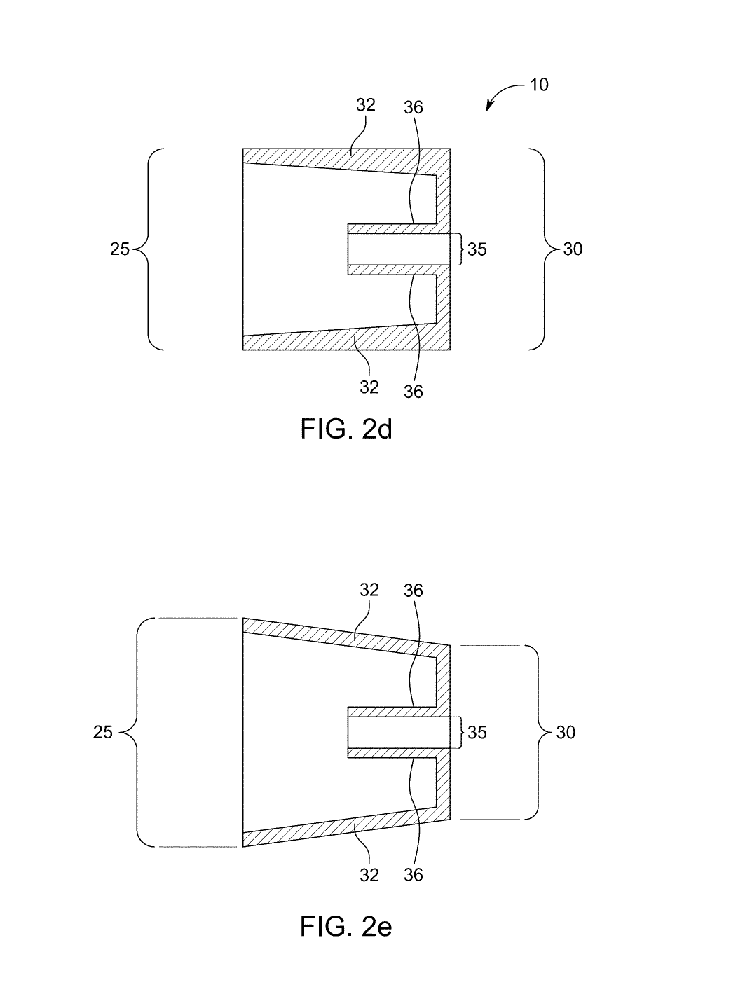

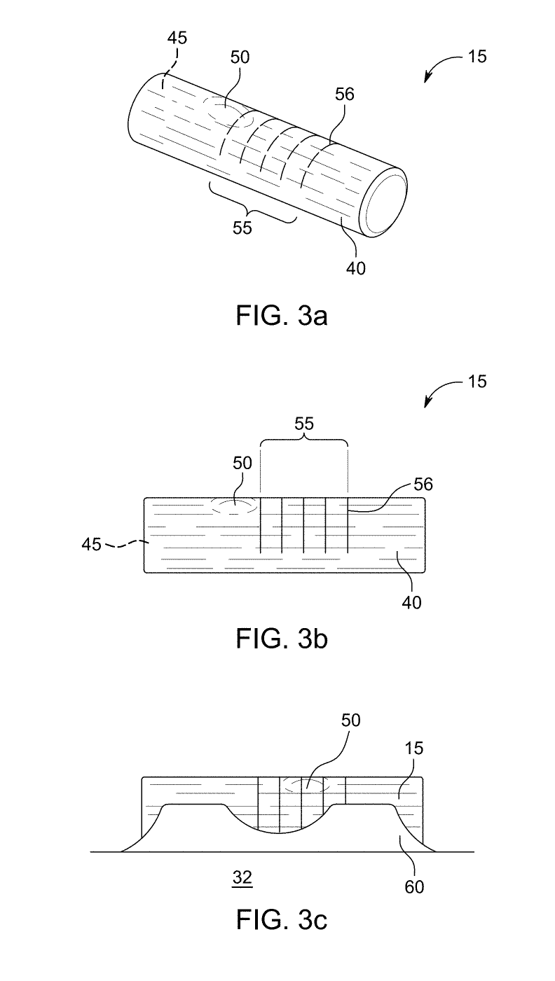

As illustrated in FIGS. 2a-2c, cup 10 is configured as a hollow cylinder with open first end 25 and closed second end 30 connected by cylindrical sidewall 32. First end 25 is open to allow the device to be positioned over one end of a pipe, as set forth in more detail herein below. Second end 30 comprises face 34 that includes aperture 35 sized and shaped to allow at least a portion of laser unit 20 to extend therethrough. Particularly, aperture 35 allows the passage of a laser beam from the laser unit to a desired surface (e.g., a wall joist). Although depicted as round in the Figures, aperture 35 can be configured in any desired shape, so long as it allows cooperation with laser unit 20. Thus, the aperture can have a circular, rectangular, oval, square, triangular, abstract, etc. shape. Further, in some embodiments the aperture can be positioned in the approximate center of face 34, although the presently disclosed subject matter is not limited and the aperture can be positioned at any location.

Face 34 can be vertically disposed as shown in FIG. 2c, or can be angled, shaped, or otherwise configured into any desired shape. In some embodiments, housing 36 is positioned adjacent to aperture 35. Housing 36 is sized and shaped to house laser unit 20. For example, in some embodiments, the housing can be shaped as an elongated cylinder that is open on one or both ends to allow the laser unit to be housed therein. However, the shape of housing 36 is not limited and can be configured in any desired shape. In some embodiments, housing 36 is sized and shaped to mimic the laser unit and thus ensure a snug fit.

In some embodiments the interior of sidewall 32 can be angled to allow the device to tilt when installed on a pipe so that a desired slope can be achieved during use. Particularly, FIG. 2d illustrates one configuration of cup 10 wherein the thickness of sidewall 32 increases as it travels from first end 25 to second end 30. FIG. 2e illustrates an alternate embodiment wherein the sidewalls 32 are of uniform thickness, but are angled inward from the first to the second end. It should be appreciated that the angled sidewall design will increase ease of manipulation of the device to a desired slope when positioned over one end of a pipe. It should further be appreciated that in some embodiments, the interior of sidewall 32 comprises a very slight angle (e.g., 0, 1, 2, 3, 4, or 5 degrees) or is not angled at all.

Cup 10 can be configured in any desired size. However, the cup will typically have an inner diameter larger or slightly larger than the size of the outer diameter of the pipe it is to be used with. To this end, cup 10 can be of any desired size to fit on any desired pipe. For example, the cup can be used with pipes with external diameters of about 1, 2, 3, 4, 5, 6, 7, 8, 9, or 10 inches. However, the presently disclosed subject matter Is not limited and the device can be used with pipes of any size. In some embodiments, the pipe used with the disclosed device can be of the type used in plumbing or sewer applications, as would be known in the art.

Cup 10 can be constructed from any rigid or semi-rigid material known or used in the art. The term “rigid” as used herein refers to a material that has a substantially stiff structure that resists bending and is not generally flexible. The term “semi-rigid” as used herein refers to a material that holds a shape without external support, but exhibits higher flexibility when external forces are exerted on the material. Thus, cup 10 can be constructed from plastic, metal (e.g., aluminium), wood, cardboard, chipboard, stiff paper, foamed plastics, recycled materials, compostable materials, heavy foil, and/or combinations thereof. Such materials are typically suitable for forming, yet stiff or rigid enough to resist buckling, folding, crumbling or collapsing due to compression, handling, and shipping. The material used to construct cup 10 is typically portable, lightweight, easy to use, and durable.

Cup 10 can be constructed using any conventional process known or used in the art. For example, in some embodiments, the cup can be constructed by rotational molding, blow molding, injection molding, casting, roll forming, stamping, billet machining, and the like. The cup can be formed as one integral piece or can be configured as multiple components joined together.

As set forth above, device 5 comprises slope level 15 for easy pitch determination relative to a horizontal ground axis. Particularly, in the field of building construction, pipes are usually required to be constructed at an acute angle to the horizontal to allow for complete draining of water being transported. For instance, drain pipes can be required by building codes to be installed at a slope of ⅛ inch per foot, ¼ inch per foot, or ½ inch per foot, depending on the particular application. These slopes correspond to approximate angles from the horizontal of 0.60 degrees, 1.2 degrees, and 2.4 degrees, respectively. The term “slope” or “pitch” as used herein typically refers to a downward inclination or slant.

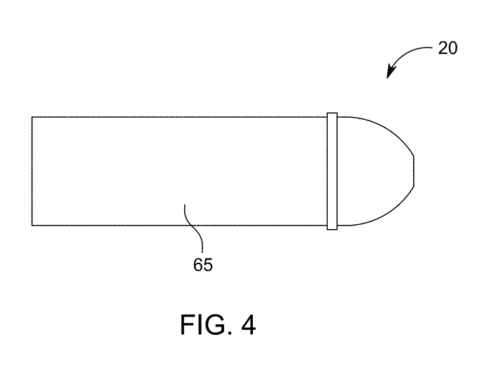

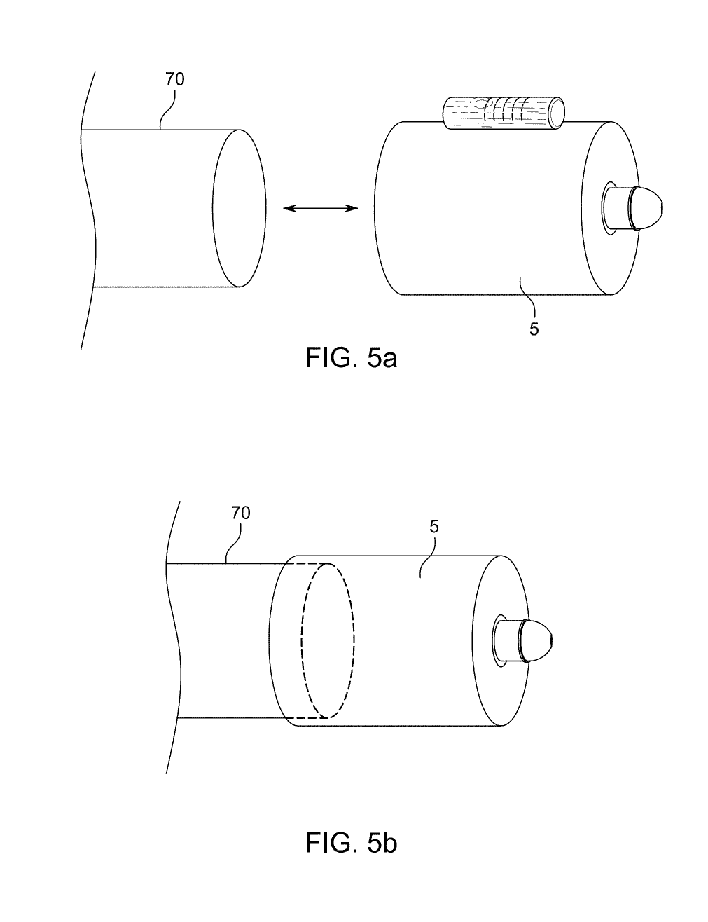

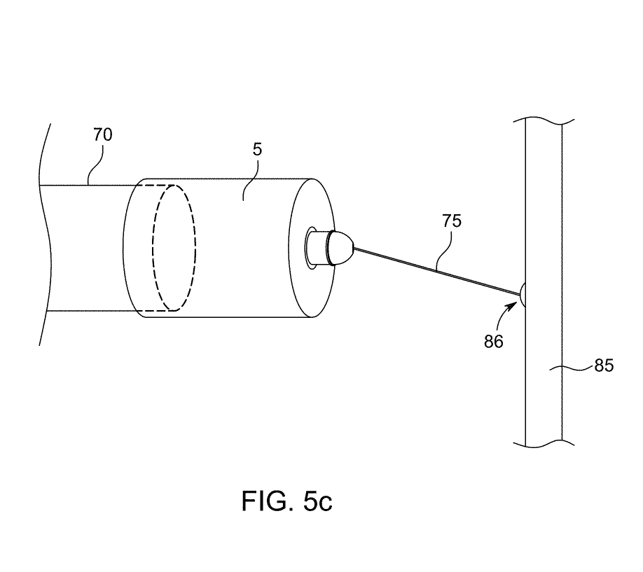

As shown in FIGS. 3a and 3b, slope level 15 can include elongate tube 40 configured in any desired shape, such as (but not limited to) rectangular, cylindrical, rounded, and the like. In some embodiments, tube 40 is constructed from at least partially transparent material, such as glass or clear plastic. However, the tube can be constructed from semi-transparent or opaque materials with a clear or transparent reading window. The tube can have a colored tint in some embodiments to increase visibility during use. Tube 40 is sealed so that it is air tight. The interior of the tube comprises liquid 45 and a small amount of gas that forms bubble 50 within the liquid. Alternatively, tube 40 can comprise two immiscible fluids with different densities, such as oil and water to form bubble 50. In some embodiments, liquid 45 can be colored to increase visibility.

Tube 40 further comprises markings 55 located on the top surface thereof that allow the user to determine a particular slope. In some embodiments, markings 55 can include an indication of a downward slope of 0, ½, ¼, ⅛, or 1/16th of an inch per one foot of drainage pipe. However, it should be understood that markings 55 can include any desired indication of angular position. It should also be appreciated that instead of having two or more markings 55 (e.g., ½ inch or ¼ inch), the slope level can be provided with a single marking. In some embodiments, the markings can be configured with spaced apart lines 56 so that a that level is at the required slope when bubble 50 is centered between the lines. The markings can be engraved, painted, printed, or otherwise formed on the upper surface of the housing.

Bubble 50 has a density less than that of liquid 45, so that the bubble will always rise in the vertical direction to achieve a position above that of the liquid. Thus, when slope level 15 is inclined or declined, the bubble will move in a longitudinal direction along the length of housing 40. The user can observe the position of bubble 50 through the housing aligned with a particular marking, thus providing the user with a visual indication of the angular position of the device and the pipe to which the housing is attached.

In some embodiments, the slope level is directly attached to one surface of cup sidewall 32 (e.g., the top surface in some embodiments) using welding, adhesives, and the like such that the slope level is permanently attached to the body. In other embodiments, the sidewall 32 includes brace 60 that cooperates with slope level 15, as illustrated in FIG. 3c. In these embodiments, the slope level can be replaced when damaged and/or interchanged with slope levels with differing markings. Brace 60 can be constructed from wood, metal, fiberglass, plastic, and the like. Brace 60 can cooperate with slope level 15 using any mechanism known in the art, such as a snap fit arrangement, the use of mechanical closures (clips, screws, etc.), and so forth. The slope level is positioned within the brace such that bubble 50 and markings 55 are visible to the user.

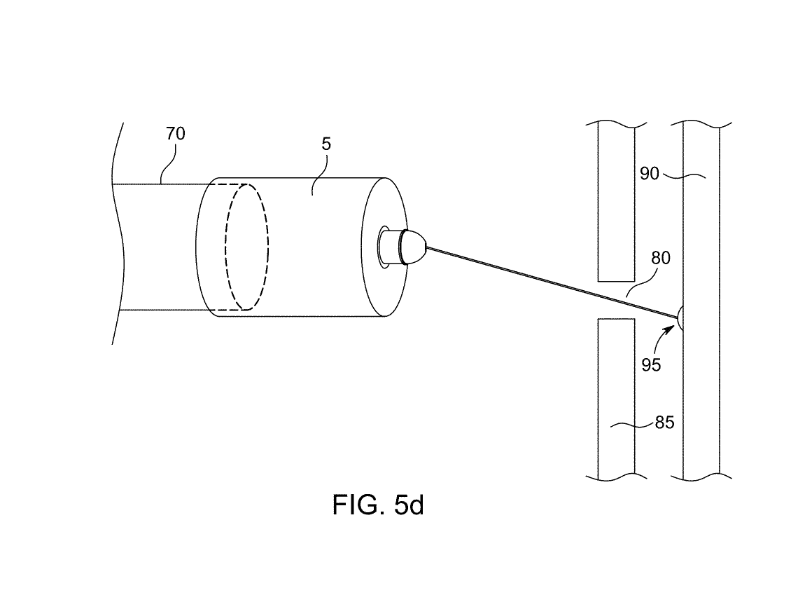

Device 5 further comprises laser unit 20, as illustrated in FIG. 4. The laser unit typically is provided with a tubular housing 65 having an elongate axis and containing a light source (such as a laser). The laser unit can be configured such that the light-emitting end extends through aperture 35. In some embodiments, the light-emitting end is interchangeable. In some embodiments, one end of the laser unit includes threads that cooperate with threads on aperture 35 to maintain the laser in a desired position within cup 10 and to prevent movement. Alternatively, the laser unit can be held in position with a snap-fit or other removable arrangement, in addition to housing 36. In some embodiments, laser unit 20 is releasably attached to aperture 35 to allow for different units (e.g., different sized lasers) to be interchanged. However, the presently disclosed subject matter also includes embodiments wherein the laser unit is permanently mounted to cup 10. In some embodiments, the laser unit includes an internal battery source for energizing the beam circuitry.

Suitable laser units include those capable of producing a laser beam (or beam of light) on a surface, visible as a spot of white or colored light. Commercial laser units can be used, such as (but not limited to) low-cost infrared diode laser modules of up to 1000 mW (1 watt) output. However, the laser unit is not limited and can include any device used to generate a narrow projection of light energy, such as an incandescent lamp or light emitting diode which in certain embodiments can be focused with a reflector. In some embodiments, the laser unit is a Class III laser, which satisfies the specifications and standards stipulated for consumer use.

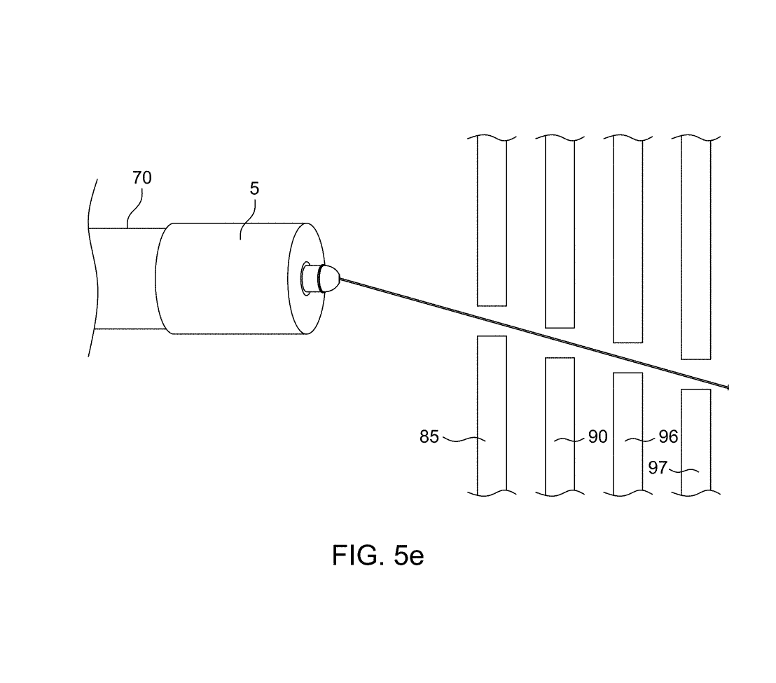

In use, device 5 is assembled by attaching slope level 15 directly to sidewall 32 or to housing 60. Laser unit 20 is inserted into housing 36 of cup 10 to arrive at the configuration of FIG. 1. In some embodiments, the portion of laser unit 20 that shines the laser extends through aperture 35. Once assembled, first end 25 (e.g., the open end) of cup 10 is positioned over one end of pipe 70 as shown in FIGS. 5a and 5b. In some embodiments, pipe 70 can extend through a starter hole in a starter joist, but it is not required. Particularly, device 5 can be sized to easily fit within the joist cavity (e.g., area between joists) such that a starter joist hole is not required.

The cup can be angled to a desired slope, as indicated by bubble 50 and markings 55 of slope level 15. In embodiments where sidewall 32 of the cup is angled, the cup (and slope level) can be easily adjusted and/or tilted to the desired slope. Once a desired slope has been achieved, the laser unit is then initiated to provide a visual indicator for drilling multiple joist holes at a set pitch from pipe 70. The laser unit can be initiated using any of a wide variety of methods, such as pushing a button, flipping an “on” switch, and the like. As shown in FIG. 5c, line 75 indicates desired path of a new pipe that is pitched as required. The laser unit will mark first joist 85 with first dot 86 at the proper pitch line. The user then drills first hole 80 in first joist 85 at the location indicated by laser light dot 86, as shown in FIG. 5d. The laser, still at the appropriate pitch, shines through first hole 80 in the first joist and travels at the correct pitch to create laser dot 95 on second successive joist 90. The user drills second hole 100 in the second joist and the process repeats itself for any number of successive joists. The same process is repeated to achieve multiple accurately aligned drill holes, as shown in joists 85, 90, 96, 97 of FIG. 5e.

Advantageously, the disclosed alignment device provides a quick and accurate way to locate marks for drilling multiple holes that slope at a desired angle. As such, the need to measure, level, and mark individual joists one-by-one is eliminated. Accordingly, disclosed device enables a user to locate and drill aligned holes in an efficient manner, thereby saving valuable time and reducing the need for additional tools, such as plumb lines, caulk lines, sight wires, and the like. The disclosed device further advantageously allows one person instead of multiple workers to pinpoint drilling locations and accurately align components and structures to a desired slope.

What is claimed:

1. A device for sloped laser sighting, comprising:
a cup comprising an interior, an open first end, a closed second end, and a sidewall that connects the open first end and the closed second end, wherein the closed second end comprises a face with an aperture configured therein, and wherein the interior comprises a housing positioned adjacent to the closed second end, sized and shaped to contain a laser unit;
a slope level comprising an interior that houses a liquid and a bubble of gaseous fluid disposed at a location within the liquid, wherein the location is an indicator of slope of the device; and
a laser unit disposed within the cup housing, wherein one end of the laser unit extends through the aperture, and wherein the extended end is configured to emit a light therefrom;
wherein the sidewall tapers inward from the first open end of the cup to the second closed end.

2. The device of claim 1, wherein the sidewall has an exterior that comprises a brace sized and shaped to house the slope level.

3. The device of claim 1, wherein the cup is constructed from plastic, metal, wood, cardboard, chipboard, stiff paper, foamed plastics, recycled materials, compostable materials, heavy foil, or combinations thereof.

4. The device of claim 1, wherein the slope level comprises markings that indicate a downward slope of ⅛ inch, ¼ inch, or ½ inch per foot.

5. The device of claim 1, wherein the liquid of the slope level is colored to increase visibility.

6. The device of claim 1, wherein the laser unit is releasably disposed within the housing.

7. The device of claim 1, wherein the sidewall has an outer surface that comprises a brace that releasably houses the slope level.

8. The device of claim 1, wherein pen first end of the cup is configured to fit over one end of a pipe.

9. The device of claim 1, wherein the laser unit comprises an internal battery source for energizing a beam circuitry.

10. A method of marking a hole location at a desired slope in a structure, the method comprising:
positioning a device for sloped laser sighting on one end a pipe, wherein the device comprises:
a cup comprising an interior, an open first end, a closed second end, and a sidewall that connects the open first end and the closed second end, wherein the closed second end comprises a face with an aperture configured therein, and wherein the interior comprises a housing positioned adjacent to the closed second end, sized and shaped to contain a laser unit;
a slope level comprising an interior that houses a liquid and a bubble of gaseous fluid disposed at a location within the liquid, wherein the location is an indicator of slope of the device; and
a laser unit that emits a light from one end disposed within the housing;
wherein the sidewall tapers inward from the first open end of the cup to the second closed end;
tilting the device to a desired slope as indicated by the bubble location in the slope level; and
initiating the laser unit to emit light to mark a location for a first hole in a first structure where indicated by the laser.

11. The method of claim 10, further comprising:
drilling a hole in the first structure at the location marked; and
marking a location for a second hole in a second structure where indicated by the emitted light passing through the first hole to align the first hole in the first structure with the marked location on the second structure at a desired slope.

12. The method of claim 10, wherein the structure is a joist.

13. The method of claim 10, wherein the desired slope is a downward slope of ⅛ inch, ¼ inch, or ½ inch per foot.

14. The method of claim 10, wherein the laser unit is releasably disposed within the housing.

15. A method of forming a plurality of aligned holes, the method comprising:
positioning a device for sloped laser sighting on one end a pipe, wherein the device comprises:
a cup comprising an interior, an open first end, a closed second end, and a sidewall that connects the open first end and the closed second end, wherein the closed second end comprises a face with an aperture configured therein, and wherein the interior comprises a housing positioned adjacent to the closed second end, sized and shaped to contain a laser unit;
a slope level comprising an interior that houses a liquid and a bubble of gaseous fluid disposed within the liquid, wherein the bubble location is an indicator of slope of the level; and
a laser unit that emits a light from one end disposed within the housing;
wherein the sidewall tapers inward from the first open end of the cup to the second closed end;
tilting the device to a desired slope as indicated by the bubble location in the slope level; and
initiating the laser unit to emit light to mark a location for a first hole in a first structure where indicated by the laser;
drilling a hole at the marked location in the first structure;
marking a location for a second hole in a second structure where indicated by the emitted light passing through the first hole; and
drilling a second hole in the location marked on the second structure;
wherein the first hole and the second hole are aligned at a desired slope.

16. The method of claim 15, wherein the first and second structures are joists.

17. The method of claim 15, wherein the desired slope is a downward slope of ⅛ inch, ¼ inch, or ½ inch per foot.

18. The method of claim 15, wherein the laser unit releasably disposed within the housing.

19. The method of claim 15, wherein the sidewall has an outer surface that comprises a brace that releasably houses the slope level.

20. The method of claim 15, wherein the method further comprises:
drilling one or more successive holes marked on successive structures, wherein the successive holes are aligned with the first and second holes at a desired slope.
